(19) United States
(12) Patent Application Publication
(10) Pub. No.: US 2025/0308120 A1
(43) Pub. Date: Oct. 2, 2025

(54) Rich-Media Document Auxiliary Generation Apparatus

(71) Applicant: THE 10TH RESEARCH INSTITUTE OF CHINA ELECTRONICS TECHNOLOGY GROUP CORPORATION, Chengdu (CN)

(72) Inventors: Xiang DAI, Chengdu (CN); Xiang GAO, Chengdu (CN); Weiqing CHEN, Chengdu (CN); Ying CUI, Chengdu (CN); Jianjun HE, Chengdu (CN); Hongzhou LIAO, Chengdu (CN); Lei PAN, Chengdu (CN); Hongli DING, Chengdu (CN); Xifeng HUANG, Chengdu (CN); Lican DAI, Chengdu (CN); Kan WANG, Chengdu (CN)

(21) Appl. No.: 19/236,960

(22) Filed: Jun. 12, 2025

Related U.S. Application Data
(63) Continuation of application No. PCT/CN2023/108225, filed on Jul. 19, 2023.

(30) Foreign Application Priority Data
Dec. 19, 2022 (CN) 202211632138.4

(51) Int. Cl. G06T 11/60; G06F 40/166; G06F 40/274; G06F 40/279; G06F 40/30; G10L 13/02; G11B 27/036

(52) U.S. Cl. CPC G06T 11/60; G06F 40/166; G06F 40/274; G06F 40/279; G06F 40/30; G10L 13/02; G11B 27/036

(57) ABSTRACT

Disclosed in the present disclosure is a rich-media document auxiliary generation apparatus. The apparatus comprises a material extraction module, a theme sorting module, a semantic retrieval module, a structured data text generation module, an illustration recommendation module and a video composition module. The present disclosure uses intelligent means to assist a user to efficiently generate a high-quality rich-media composite document, thereby quickly and accurately describing a theme event in an all-round way.

### CROSS-REFERENCE TO RELATED APPLICATIONS

The present disclosure claims priority to Chinese Patent Application No. 202211632138.4, to the China National Intellectual Property Administration on Dec. 19, 2022 and entitled “Rich-Media Document Auxiliary Generation Apparatus”, which is incorporated herein by reference in its entirety.

### TECHNICAL FIELD

The present disclosure relates to the technical field of natural language processing, and in particular, to a rich-media document auxiliary generation apparatus.

### BACKGROUND

In today's society, hot events can potentially occur in various fields every day. Conducting research around thematic events is an important task, and an increasing number of journalists and self-media workers are beginning to engage in the writing of comprehensive articles. Traditional research outcomes on thematic events are primarily presented in a form of text, with images serving as supplementary elements. Humans are visual creatures, and the transmission of information through video is far richer than through text or images, and it also leaves a more lasting impression on memory.

However, transforming a text into a rich-media video document requires tasks such as video material collection, voiceover writing, voiceover recording and video editing before it can be officially published, this process is highly complex and involves a significant amount of work, and the prior art lacks auxiliary means for improving the efficiency of generation of rich-media documents.

### SUMMARY

The objective of the present disclosure is to overcome the shortcomings of the prior art and provide a rich-media document auxiliary generation apparatus, which uses an intelligent means to assist a user in efficiently generating a comprehensive high-quality rich-media document, and quickly and accurately describes a thematic event in an all-round way.

The objective of the present disclosure is achieved by the following solutions:
a rich-media document auxiliary generation apparatus, including:
a material extraction module, configured to extract writing materials for generating a rich-media document from received raw materials;
a theme sorting module, configured to cluster the writing materials by theme, respectively extract keywords from clustered writing materials as a theme for each cluster article, as to form a theme list, use a pre-constructed user profile to score the theme list, and sort the theme list based on a scoring result;
a semantic retrieval module, configured to acquire a semantic vector of text information based on the received text information, and retrieve semantically similar text segments from the writing materials based on the semantic vector;
a structured data text generation module, configured to convert structured data obtained by an intelligent analysis engine into a natural language text;
an illustration recommendation module, configured to recommend an illustration with a matching degree reaching a threshold based on the semantic information of an input text; and
a video composition module, configured to generate a video based on the input text.

In an embodiment, the material extraction module includes a paragraph extraction sub-module, a summary extraction sub-module, a quotable sentence detection sub-module, and a knowledge extraction sub-module;
the paragraph extraction sub-module, configured to cluster several adjacent paragraphs based on a paragraph semantic similarity, and use a central sentence extraction model to extract central sentences from paragraphs of a same type;
the summary extraction sub-module, configured to use a generative summary model to generate a short text summary for each raw writing material;
the quotable sentence detection sub-module, configured to perform sentence segmentation on a text based on punctuation marks, score sentences by a preset scoring model, and identify a sentence of which a score exceeds a threshold as a quotable sentence; and
the knowledge extraction sub-module, configured to extract the knowledge contained in the text to form a triplets or a knowledge graph.

In an embodiment, the quotable sentence detection sub-module includes a binary classification model which is obtained by performing supervised training using labeled positive and negative samples.

In an embodiment, the material extraction module further includes an image description generation sub-module and a video description generation sub-module;
the image description generation sub-module, configured to generate image description information based on the image content by using a multimodal image-text model; and
the video description generation sub-module, configured to generate the description information based on the typical video features.

In an embodiment, extracting keywords from the clustered writing materials as the theme for each cluster article includes:
using the summary extraction model to extract summary content from the raw writing materials, and then using the central sentence extraction model to extract a central sentence or central phrase from the summary content to serve as the theme for one cluster article.

In an embodiment, the intelligent analysis engine includes a target analysis engine and an event analysis engine; the target analysis engine uses a target as a center to obtain a statistical law of the target; the intelligent analysis engine uses an event as a center to analyze the background and a development trend of the event; and the intelligent analysis engine finally outputs an analysis conclusion in a form of structured data.

In an embodiment, the apparatus further comprises a text continuation module, the text continuation module configured to use a sequence model to generate a new text segment following an end of an original text; the sequence model is trained in an unsupervised manner, wherein the unsupervised manner comprises: masking a subsequent text on the original text to predict a subsequent text based on a preceding text, and automatically performing training.

In an embodiment, the apparatus further includes a text rewrite module, and the text rewrite module, configured to use a sequence model to rewrite the input text based on a set style control variable.

In an embodiment, the apparatus further includes an intelligent summary module, and the intelligent summary module, configured to generate a summary based on semantic information of input content.

In an embodiment, the apparatus further includes an intelligent detection module and a review and evaluation module;
the intelligent detection module, configured to perform word and phrase proofreading, punctuation proofreading, syntax proofreading, common sense verification, and fact verification for an input document; and
the review and evaluation module, configured to perform quantitatively scoring the fluency, common sense compliance, and factual accuracy of the input document.

In an embodiment, the video composition module includes a document transcription sub-module, a voiceover synthesis sub-module, and a subtitle composition sub-module;
the document transcription sub-module is configured to write a document into a style based on a style-controllable sequence2sequence model;
the voiceover synthesis sub-module, configured to automatically generate an audio file based on an input video narration; and
the subtitle composition sub-module, configured to automatically segment the video narration based on punctuation marks and control a duration of subtitles in a video based on a length of each audio narration.

In an embodiment, the video composition module includes a semantic-level picture retrieval sub-module and a semantic-level video clip retrieval sub-module;
the semantic-level picture retrieval sub-module, configured to automatically retrieve a best matched picture from an image library based on semantic information of each input narration script; and
the semantic-level video clip retrieval sub-module is configured to automatically retrieve a best matched video clip from a video library based on the semantic information of each input narration script.

In an embodiment, the apparatus further includes a tag generation module and a publishing channel recommendation module;
the tag generation module, configured to generate a tag based on a video feature and the semantic information of a text; and
the publishing channel recommendation module, configured to perform publishing channel recommendation based on a user profile.

Beneficial effects of the present disclosure are as follows:
(1) The present disclosure can assist users in rapidly processing originally underutilized raw writing materials into directly usable writing resources such as quotable sentences, knowledge and multimedia description information, thereby eliminating the cumbersome process of selecting materials.
(2) A document writing process of the present disclosure provides a structured data text generation method based on an intelligent analysis engine, which enables in-depth analysis of the development context, current status, and trends of significant events through multiple event-related intelligent analysis engines, and outputs structured conclusions.
(3) By multiple artificial intelligence models, a video composition module provided in the present disclosure composes a rich-media short video having voice, streaming media and subtitles based on a comprehensive text of a document, and organically combines the text, the picture and the video to generate a rich-media composite document, thereby improving the authoring efficiency.

### BRIEF DESCRIPTION OF THE DRAWINGS

FIG. 1 is a structural block diagram of a rich-media document auxiliary generation apparatus according to an embodiment of the present disclosure;

FIG. 2 is a schematic flowchart of the generation of a rich-media composite document according to an embodiment of the present disclosure;

FIG. 3 is a schematic flowchart of material importing according to an embodiment of the present disclosure;

FIG. 4 is a schematic flowchart of content planning according to an embodiment of the present disclosure;

FIG. 5 is a schematic flowchart of document writing according to an embodiment of the present disclosure;

FIG. 6 is a schematic flowchart of an intelligent proofreading process according to an embodiment of the present disclosure;

FIG. 7 is a schematic flowchart of video composition according to an embodiment of the present disclosure.

### DETAILED DESCRIPTION OF THE EMBODIMENTS

Hereinafter, the embodiments of the present disclosure are described by examples, and those skilled in the art can easily understand other advantages and effects of the present disclosure from the contents in the description. The present disclosure can also be implemented or applied through other different embodiments. Various details in the present description can also be modified or changed in various ways based on different viewpoints and applications without departing from the spirit of the present disclosure. It should be noted that the embodiments and features in the embodiments can be combined without conflicts.

All other embodiments obtained by a person of ordinary skill in the art based on the embodiments of the present disclosure without any inventive effort shall all fall within the scope of protection of the present disclosure.

However, converting a text into a rich-media video document requires tasks such as video material collection, voiceover writing, voiceover recording and video editing before it can be officially published, this process is highly complex and involves a significant amount of work.

In order to solve the described technical problem, the following embodiments of a rich-media document auxiliary generation apparatus according to the present disclosure are provided.

### Embodiment 1

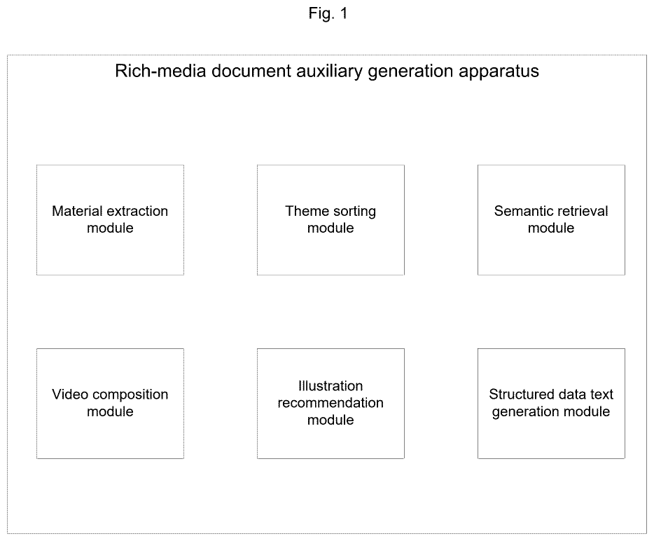

Referring to FIG. 1, FIG. 1 is a structural block diagram of a rich-media composite document auxiliary generation apparatus according to an embodiment of the present disclosure, the apparatus In an embodiment includes the following structures:

a material extraction module, configured to extract writing materials for generating a rich-media document from received raw materials.

The material extraction module includes a paragraph extraction sub-module, a summary extraction sub-module, a quotable sentence detection sub-module, and a knowledge extraction sub-module.

The paragraph extraction sub-module clusters several adjacent paragraphs based on a paragraph semantic similarity, and uses a central sentence extraction model to extract central sentences from paragraphs of a same type. The central sentence extraction model in the present embodiment may select TextRank, BERTsum, etc. A text is inputted to the central sentence extraction model; the central sentence extraction model first segments the text into sentences, then performs intelligent sorting based on the semantic features of the sentences, and finally outputs sentences with higher rankings as the central sentences of the text.

The summary extraction sub-module uses a generative summary model to generate a short text summary for each raw writing material. The generative summary model in the present embodiment may use BART, UNILM, etc. A text is inputted to the generative summary model, and the generative summary model first encodes the text, then outputs the code of the summary word by word in a self-regression manner, and then outputs the text content of the summary by a decoder.

The quotable sentence detection sub-module performs sentence segmentation on a text based on punctuation marks, scores the sentences by a preset scoring model, and identifies a sentence of which a score exceeds a threshold as a quotable sentence. The scoring model in the present embodiment may be a regression-type machine learning model, such as an LMS-based linear regression or a Volterra series-based nonlinear regression;

The scoring model takes a text as an input, first encodes the text; the text code passes through a corresponding neural network to output a score corresponding to the text; and the calculation method of the neural network varies depending on the algorithm used.

The knowledge extraction sub-module extracts knowledge contained in the text to form a triplets or a knowledge graph.

The quotable sentence detection sub-module in the present embodiment includes a binary classification model which is obtained by performing supervised training using labeled positive and negative samples.

As an implementation, the material extraction module of the present embodiment further includes an image description generation sub-module and a video description generation sub-module.

The image description generation sub-module, configured to generate image description information based on the image content by using a multimodal image-text model. The multimodal image-text model in the present embodiment may use cross-stream, VILBERT, etc. The multimodal image-text model takes an image as an input; and the multimodal image-text model performs target recognition, scenario recognition, etc. on the image to understand the image, to output a description text of the image.

The video description generation sub-module generates description information based on typical video features.

The theme sorting module is configured to cluster the writing materials by theme, respectively extract keywords from the clustered writing materials as the theme for each cluster article, as to form a theme list, use a pre-constructed user profile to score the theme list, and sort the theme list based on a scoring result.

In an embodiment, the summary extraction model is configured to extract summary content from the raw writing materials, and then the central sentence extraction model is configured to extract a central sentence or central phrase from the summary content to serve as the theme for one cluster article.

The semantic retrieval module is configured to acquire a semantic vector of text information based on the received text information, and retrieve semantically similar text segments from the writing materials based on the semantic vector.

The structured data text generation module is configured to convert structured data obtained by an intelligent analysis engine into a natural language text.

The illustration recommendation module is configured to recommend an illustration with a matching degree reaching a threshold based on the semantic information of an input text.

The video composition module is configured to generate a video based on the input text.

As an implementation, the video composition module in the present embodiment includes a semantic-level picture retrieval sub-module and a semantic-level video clip retrieval sub-module,
wherein the semantic-level picture retrieval sub-module is configured to automatically retrieve a best matched picture from an image library based on the input semantic information of each input narration script; and
the semantic-level video clip retrieval sub-module is configured to automatically retrieve a best matched video clip from a video library according to the semantic information of each input narration script.

The video composition module in the present embodiment uses multiple artificial intelligence models to compose a rich-media short video having voice, streaming media and subtitles based on a comprehensive text of a document, and organically combines the text, the picture and the video to generate a rich-media composite document, thereby improving the authoring efficiency.

As an implementation, the rich-media document auxiliary generation apparatus in the present embodiment further includes a tag generation module and a publishing channel recommendation module. The tag generation module generates a tag based on a video feature and the semantic information of a text; and the publishing channel recommendation module performs publishing channel recommendation based on a user profile.

As an implementation, the rich-media document auxiliary generation apparatus in the present embodiment further includes a text continuation module, the text continuation module, configured to use a sequence model to generate a new text segment following an end of an original text, and the sequence model is trained in an unsupervised manner, wherein the unsupervised manner comprises: masking a subsequent text on the original text to predict a subsequent text based on a preceding text, and automatically performing training.

As an implementation, the rich-media document auxiliary generation apparatus in the present embodiment further includes a text rewrite module, and the text rewrite module uses a sequence model to rewrite the input text based on a set style control variable.

As an implementation, the rich-media document auxiliary generation apparatus in the present embodiment further includes an intelligent summary module, and the intelligent summary module generates a summary based on semantic information of input content.

As an implementation, the rich-media document auxiliary generation apparatus in the present embodiment further includes an intelligent detection module and a review and evaluation module.

The intelligent detection module performs word and phrase proofreading, punctuation proofreading, syntax proofreading, common sense verification, and fact verification for an input document. The review and evaluation module perform quantitatively scoring the fluency, common sense compliance, and factual accuracy of the input document.

The rich-media document auxiliary generation apparatus provided in the present embodiment can assist users in rapidly processing originally underutilized raw writing materials into directly usable writing resources such as quotable sentences, knowledge and multimedia description information, thereby eliminating the cumbersome process of material selection.

### Embodiment 2

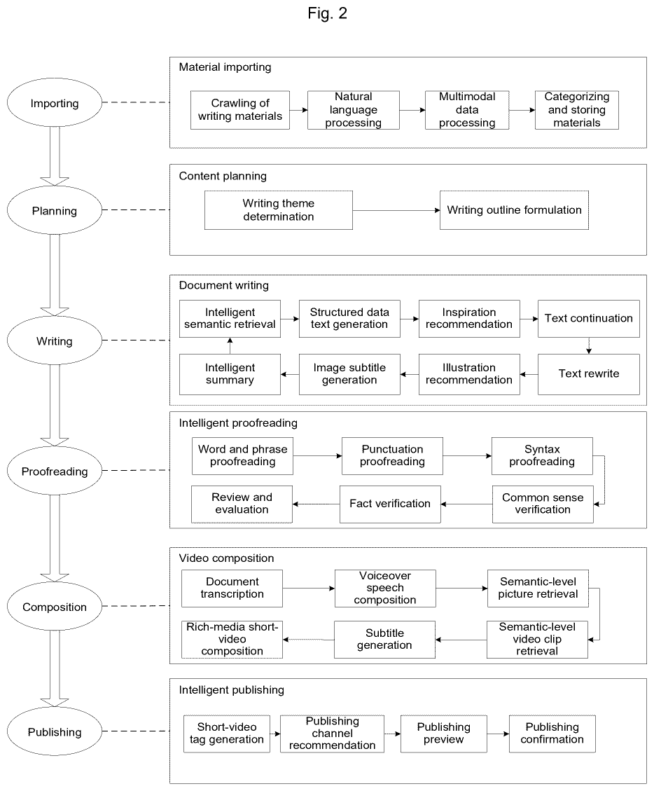

The present embodiment provides an application example of the rich-media document auxiliary generation apparatus provided in the foregoing embodiment. FIG. 2 is a schematic flowchart of the generation of a rich-media composite document provided in the present embodiment. The method includes the following steps:

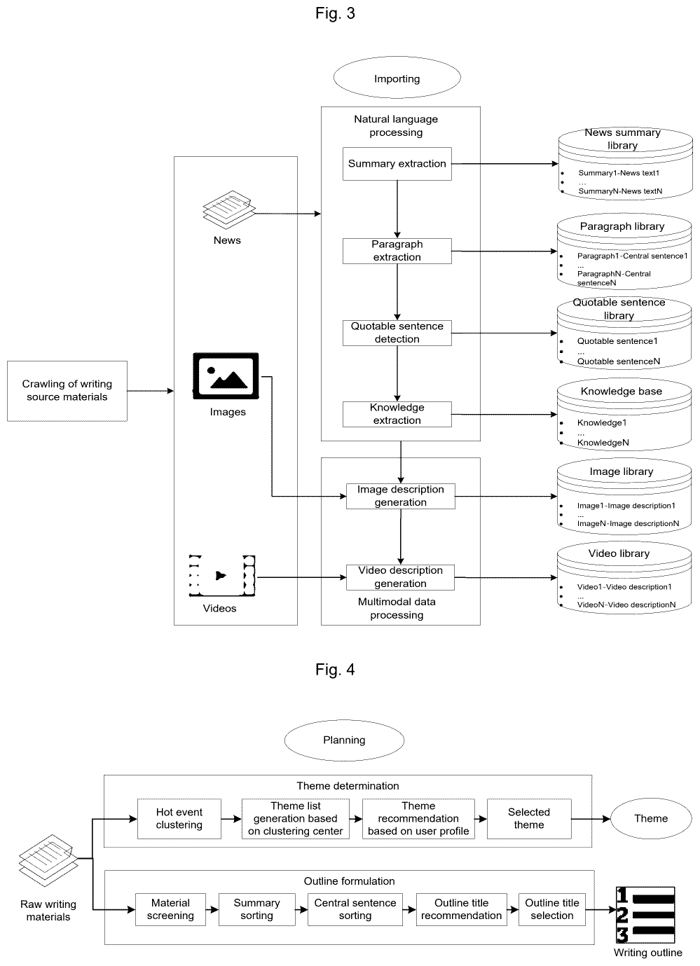

Step 1: writing materials are imported, referring to FIG. 3, FIG. 3 is a schematic flowchart of material importing in the present embodiment, and the step 1 is as follows:

The writing materials not only contain the acquired news text, but also include materials such as paragraph center sentences, quotable sentences, knowledge, image descriptions and video descriptions on which natural language processing and multimodal data processing have been performed. The raw writing materials can be acquired based on an acquisition program that is directed to acquire elements such as news, images and videos from websites. After the raw writing materials are imported into a system, natural language processing is required. This includes a paragraph extraction module, a summary extraction module, a quotable sentence detection module and a knowledge extraction module. The summary extraction sub-module uses a generative summary model to generate a short text summary for each raw writing material, and stores news text and the corresponding summary thereof into a news summary library. The paragraph extraction module first uses a paragraph clustering function to cluster several adjacent paragraphs based on a paragraph semantic similarity, uses a central sentence extraction model to extract the central sentences of the paragraphs of a same type, and stores the clustered paragraphs and the corresponding central sentences into a paragraph library. The quotable sentence detection module first segments the text into sentences based on punctuation marks such as a full stop, an exclamation mark and a question mark, then identifies sentences that are complete in description elements, excellent in description style and clear in description content as quotable sentences, and stores the sentences in a quotable sentence library. The detection of quotable sentences is implemented by a binary classification model which is obtained by performing supervised training using labeled positive and negative samples. The knowledge extraction module can extract knowledge contained in the text, and store the extracted knowledge in the knowledge base in the form of triples or knowledge graphs. The image description generation module may process acquired images and image data in news, use a multimodal image-text model to generate, based on the image content, one-sentence description information which can be used as an important reference for subsequent writing material retrieval and image subtitle, and store the processed image and description information thereof in the image library. The video description generation module may process acquired video data, generate one-sentence description information based on typical video features, and store the processed video data and the description information thereof in the video library. The writing materials from the news summary library, paragraph library, quotable sentence library, knowledge base, image library, and video library serve are important inputs for generation of a rich-media composite document.

During the material importing process, a variety of natural language processing and multimedia material processing models are configured to process originally underutilized raw writing materials into directly usable writing resources such as quotable sentences, knowledge and multimedia description information. All these steps are completed at the backend of material importing, ensuring that no additional time is required for the user during the writing process. The content planning process can use massive writing materials to assist a user in quickly ascertaining a writing theme, constructing a writing outline, and explicitly determining the writing logic.

Step 2: content planning is performed, referring to FIG. 4, FIG. 4 is a schematic flowchart of content planning according to the present embodiment, and the step 2 is as follows:

In the theme formulation process, firstly, unsupervised clustering is performed on a hotspot event based on a raw writing material; and by an unsupervised clustering model of a text, theme-based clustering of the raw writing material is realized. After the calculation of the cluster centers, the raw writing materials located at the cluster centers are used as an input; the summary extraction model is configured to extract the summary content from these raw writing materials; then the central sentence or phrase extraction model is configured to extract a central sentence or phrase to serve as the theme for a cluster article, and by analogy, the themes for all clusters of articles are calculated, to form a theme list. In addition, in combination with a user profile constructed based on user's operation behaviors, such as reading, editing and writing, the themes in the theme list are scored, and the scoring model is a regression model, and is trained in a supervised manner. The theme list is sorted based on a scoring result, and is recommended to a writing user; and a user may select a writing theme based on a recommendation result.

The input of the outline formulation process is a clustered article set corresponding to the selected theme. First, based on the clustered article set, articles related to the present writing are further screened. Then, scoring is performed by using the corresponding article summary in the news summary library and the central sentences in the paragraph library; and the scoring model is a regression model and is trained in a supervised manner. Based on the high-scoring summaries and central sentences, phrase-style outline titles are generated and recommended to the writing user; the writing user then performs selection based on the recommended outline title list to formulate the outline of the current writing.

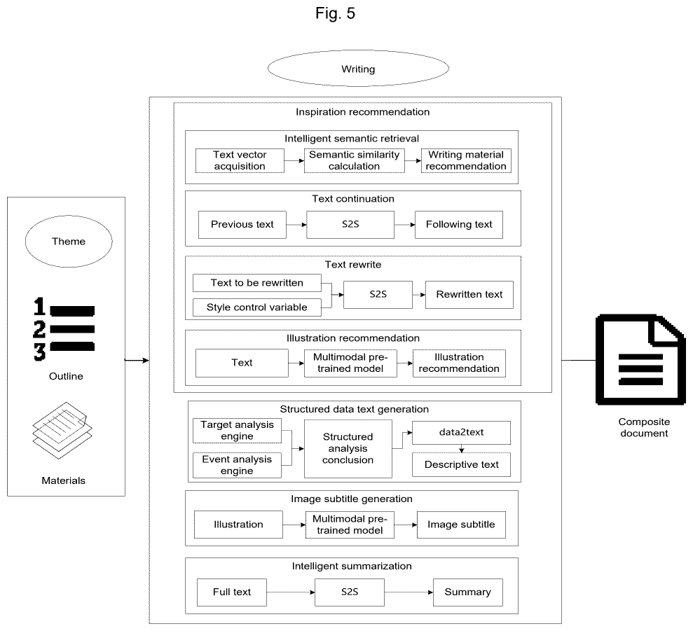

Step 3: a document is written, referring to FIG. 5, FIG. 5 is a schematic flowchart of document writing according to the present embodiment, and the step 3 is as follows:

Document writing includes several parts: intelligent semantic search, structured data text generation, inspiration recommendation, text continuation, text rewriting, illustration recommendation, image subtitle generation, and intelligent summary, there is no strict sequence among the several parts, and each part provides an auxiliary capability for writing users based on requirements. Intelligent semantic retrieval supports semantic-level multimodal writing material retrieval, which takes a text as an input and acquires a semantic vector of the text using large-scale pre-trained language models, and can find writing materials such as semantically similar paragraphs, summaries, quotable sentences, knowledge and images from the writing material library, thereby assisting document writing of users. Structured data text generation can convert structured data into a natural language text. The structured data comes from the intelligent analysis engine; the target analysis engine uses a target as a center to obtain a statistical law of the target; the intelligent analysis engine uses an event as a center to analyze the background and development trend of the event. The intelligent analysis engine finally outputs an analysis conclusion in a form of structured data; and a data2text module can convert the structured analysis conclusion into a natural language to assist writing of users.

Text continuation takes a text as an input and uses a sequence2sequence (S2S) model to generate a new text following an end of the raw text. The S2S model is trained in an unsupervised manner, wherein the unsupervised manner comprises: masking a subsequent text for the raw original text to predict the subsequent text based on a preceding text, and automatically performing training.

The text rewriting takes a text and a style control variable as an input, and the input text can be rewritten based on a designated style using the S2S model. The illustration recommendation takes a text as an input, and recommends several most matched illustrations to a writing user based on semantic information of the input text, and illustration recommendation is implemented based on a multimodal pre-trained model. The image subtitle generation takes illustrations as an input, and generating a one-sentence text description as an image subtitle based on the multimodal pre-trained model.

The inspiration recommendation supports the users by taking their written content as an input when a user encounters a bottleneck during the writing process, and comprehensively utilize intelligent semantic retrieval, text continuation, text rewriting and illustration recommendation functions based on the semantic information of the written content, thereby providing an auxiliary writing capability for users. The intelligent summary takes the writing content of the user as an input, and generates a summary based on semantic information of the writing content. The output results of various modules are integrated to finally form a composite document.

The document writing process provides a structured data text generation method based on an intelligent analysis engine, which enables in-depth analysis of the development context, current status, and trends of significant events through multiple event-related intelligent analysis engines, and outputs structured conclusions.

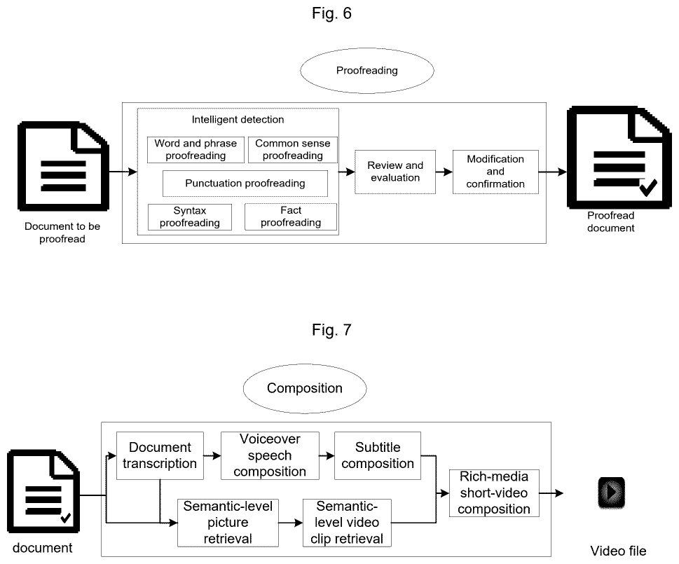

Step 4: intelligent proofreading is performed, referring to FIG. 6, FIG. 6 is a schematic diagram of an intelligent proofreading flow according to the present embodiment, and the step 4 is as follows:

The present embodiment mainly includes three main steps: intelligent detection, review and evaluation, and modification confirmation. The intelligent detection includes functions such as word and phrase proofreading, punctuation proofreading, syntax proofreading, common sense verification, and fact verification. The word and phrase proofreading includes proofreading for typos and sensitive words, which identifies typos and sensitive words in the first draft by intelligent models and provides modification suggestions. The punctuation proofreading can detect incorrect punctuation marks in the first draft and provide modification suggestions. The syntax proofreading can identify awkward or incoherent sentences in the first draft and provide a semantically identical sentence as the modification suggestion. The common sense verification can identify sentences violating common sense in the first draft based on a common-sense base at the backend and provide corresponding correct common sense in the common-sense base. The fact verification can identify sentences contradictory to facts in the first draft based on the fact base at the backend, and prompt a writing user to make a modification.

After intelligent detection is completed, comprehensive review and quantitative evaluation are performed on aspects such as the fluency, common sense compliance, and factual accuracy of the present document; and based on a detection result and an evaluation result, a user performs modification confirmation, and finally completes writing of the document.

The intelligent proofreading process not only achieves the traditional identification and correction of errors in words and phrases, punctuation marks, and syntax, but also conducts an in-depth analysis, anti-common-sense identification and anti-fact identification of the text content based on language models, effectively preventing the publishing of incorrect information.

Step 5: video composition is performed, referring to FIG. 7, FIG. 7 is a schematic flowchart of video composition according to the present embodiment, and the step 5 is as follows:

A video narration is generated by using a text transfer model based on the writing document;
subtitles with the video narration is generated, and a sound track is generated based on a speech composition model;
the narration text is segmented into sentences based on punctuation marks;
relevant images and video clips are retrieved based on semantic information of the segmented sentences;
images and videos are combined with texts in sequence to generate a video-image-text composite, finally a rich-media composite document that includes a voice narration, video images, and subtitles is generated.

The step 5 uses an intelligent means to construct and generate a short video based on a formed text; the video composition mainly consists of a text processing flow and a multimedia processing flow; the text processing flow includes several parts: text transfer, voiceover speech composition, and subtitle composition. The text transfer can transfer the text into a style suitable for the video narration, which is implemented based on a controllable S2S model. The voiceover speech composition can automatically generate a smooth audio file based on the written video narration. The subtitle composition automatically segments the video narration based on punctuation marks and controls the duration of subtitles in the video according to the length of each voiceover narration. The multimedia processing flow is mainly composed of two parts: semantic-level picture retrieval and semantic-level video clip retrieval. The multimedia processing flow can automatically find the best matched picture or video clip from the image library and the video library based on the semantic information of voiceover audio segment, the playback duration of the picture or video clip being automatically consistent with the length of each voiceover audio segment. The rich-media short-video composition module can compose the voiceover audios, video clips, pictures and subtitles to generate a rich-media short-video file.

In the video composition process of the present embodiment, multiple artificial intelligence models can be used to compose a rich-media short video having voice, streaming media and subtitles based on a comprehensive text of a document, and organically combines the text, the picture and the video to generate a rich-media composite document, thereby improving the information acquisition efficiency of a reader.

Step 6: the document is published, and the step 6 includes: short-video tag generation, publishing channel recommendation, publishing preview, and publishing confirmation. The short-video tag generation can automatically generate a tag matching the short video content based on the short video content and the document content, facilitating a subscriber to rapidly indexing the content based on his/her own reading requirements. The publishing channel recommendation utilizes an intelligent recommendation model to perform targeted publishing channel recommendation based on the user profile. The publishing preview supports previewing the generated composite document and rich-media short videos, and publishing same after it is confirmed that there is no error.

The described content merely relates to preferred embodiments of the present disclosure, and is not intended to limit the present disclosure, and any modifications, equivalent replacements, improvements, etc. made within the spirit and principle of the present disclosure shall all fall within the scope of protection of the present disclosure.

What is claimed is:

1. A rich-media document auxiliary generation apparatus, comprising:
a material extraction module, configured to extract writing materials for generating a rich-media document from received raw materials;
a theme sorting module, configured to cluster the writing materials by theme, respectively extract keywords from clustered writing materials as a theme for each cluster article, as to form a theme list, use a pre-constructed user profile to score the theme list, and sort the theme list based on a scoring result;
a semantic retrieval module, configured to acquire a semantic vector of text information based on received text information, and retrieve semantically similar text segments from the writing materials based on the semantic vector;
a structured data text generation module, configured to convert structured data obtained by an intelligent analysis engine into a natural language text;
an illustration recommendation module, configured to recommend an illustration with a matching degree reaching a threshold based on semantic information of an input text; and
a video composition module, configured to generate a video based on the input text.

2. The rich-media document auxiliary generation apparatus as claimed in claim 1, wherein the material extraction module comprises a paragraph extraction sub-module, a summary extraction sub-module, a quotable sentence detection sub-module, and a knowledge extraction sub-module;
the paragraph extraction sub-module, configured to cluster several adjacent paragraphs based on a paragraph semantic similarity, and use a central sentence extraction model to extract central sentences from paragraphs of a same type;
the summary extraction sub-module, configured to use a generative summary model to generate a short text summary for each raw writing material;
the quotable sentence detection sub-module, configured to perform sentence segmentation on a text based on punctuation marks, score sentences by a preset scoring model, and identify a sentence of which a score exceeds a threshold as a quotable sentence; and
the knowledge extraction sub-module, configured to extract knowledge contained in the text to form a triplets or a knowledge graph.

3. The rich-media document auxiliary generation apparatus as claimed in claim 2, wherein the quotable sentence detection sub-module comprises a binary classification model which is obtained by performing supervised training using labeled positive and negative samples.

4. The rich-media document auxiliary generation apparatus as claimed in claim 2, wherein the material extraction module further comprises an image description generation sub-module and a video description generation sub-module;
the image description generation sub-module, configured to generate image description information based on image content by using a multimodal image-text model; and
the video description generation sub-module, configured to generate description information based on typical video features.

5. The rich-media document auxiliary generation apparatus as claimed in claim 2, wherein extracting keywords from the clustered writing materials as the theme for each cluster article comprises:
using the summary extraction model to extract summary content from raw writing materials, and using the central sentence extraction model to extract a central sentence or central phrase from the summary content to serve as the theme for one cluster article.

6. The rich-media document auxiliary generation apparatus as claimed in claim 1, wherein the intelligent analysis engine comprises a target analysis engine and an event analysis engine; the target analysis engine uses a target as a center to obtain a statistical law of the target; the intelligent analysis engine uses an event as a center to analyze the background and a development trend of the event; and the intelligent analysis engine finally outputs an analysis conclusion in a form of structured data.

7. The rich-media document auxiliary generation apparatus as claimed in claim 1, wherein the apparatus further comprises a text continuation module, the text continuation module, configured to use a sequence model to generate a new text segment following an end of an original text; the sequence model is trained in an unsupervised manner, wherein the unsupervised manner comprises: masking a subsequent text on the original text to predict a subsequent text based on a preceding text, and automatically performing training.

8. The rich-media document auxiliary generation apparatus as claimed in claim 1, wherein the apparatus further comprises a text rewrite module, and the text rewrite module, configured to use a sequence model to rewrite the input text based on a set style control variable.

9. The rich-media document auxiliary generation apparatus as claimed in claim 1, wherein the apparatus further comprises an intelligent summary module, and the intelligent summary module, configured to generate a summary based on semantic information of input content.

10. The rich-media document auxiliary generation apparatus as claimed in claim 1, wherein the apparatus further comprises an intelligent detection module and a review and evaluation module;
the intelligent detection module, configured to perform word and phrase proofreading, punctuation proofreading, syntax proofreading, common sense verification, and fact verification for an input document; and
the review and evaluation module, configured to perform quantitatively scoring the fluency, common sense compliance, and factual accuracy of the input document.

11. The rich-media document auxiliary generation apparatus as claimed in claim 1, wherein the video composition module comprises a document transcription sub-module, a voiceover synthesis sub-module, and a subtitle composition sub-module;
the document transcription sub-module, configured to write a document into a style based on a style-controllable sequence model;
the voiceover synthesis sub-module, configured to automatically generate an audio file based on an input video narration; and
the subtitle composition sub-module, configured to automatically segment the video narration based on punctuation marks and control a duration of subtitles in a video based on a length of each audio narration.

12. The rich-media document auxiliary generation apparatus as claimed in claim 1, wherein the video composition module comprises a semantic-level picture retrieval sub-module and a semantic-level video clip retrieval sub-module;
the semantic-level picture retrieval sub-module, configured to automatically retrieve a best matched picture from an image library based on semantic information of each input narration script; and
the semantic-level video clip retrieval sub-module, configured to automatically retrieve a best matched video clip from a video library based on the semantic information of each input narration script.

13. The rich-media document auxiliary generation apparatus as claimed in claim 1, wherein the apparatus further comprises a tag generation module and a publishing channel recommendation module;
the tag generation module, configured to generate a tag based on a video feature and the semantic information of a text; and
the publishing channel recommendation module, configured to perform publishing channel recommendation based on a user profile.

14. A rich-media document auxiliary generation method, comprising:
extracting target writing materials for generating a rich-media document from received raw materials;
clustering the target writing materials by theme, respectively extracting keywords from clustered writing materials as a theme for each cluster article, as to form a theme list, using a pre-constructed user profile to score the theme list, and sort the theme list based on a scoring result;
determining a writing theme based on a sorted theme list, formulating an outline of writing based on a clustered article corresponding to the writing theme;
acquiring a semantic vector of text information, retrieving semantically similar text segments from the target writing materials based on the semantic vector, to acquire a first writing material, wherein the text information is determined based on the writing theme and the outline of writing;
converting structured data obtained by an intelligent analysis engine into a natural language text, to acquire a second writing material;
recommending an illustration with a matching degree reaching a threshold based on semantic information of the text information, to acquire a third writing material;
generating a video based on the first writing material, the second writing material and the third writing material.

15. The rich-media document auxiliary generation method as claimed in claim 14, wherein extracting target writing materials for generating a rich-media document from received raw materials comprises:
clustering several adjacent paragraphs based on a paragraph semantic similarity, and using a central sentence extraction model to extract central sentences from paragraphs of a same type;
using a generative summary model to generate a short text summary for each raw writing material;
performing sentence segmentation on a text based on punctuation marks, score sentences by a preset scoring model, and identifying a sentence of which a score exceeds a threshold as a quotable sentence;
extracting knowledge contained in the text to form a triplets or a knowledge graph;
acquiring target writing materials based on the received raw materials, the central sentences, the short text summary, the quotable sentence, the triplets or the knowledge graph.

16. The rich-media document auxiliary generation method as claimed in claim 14, wherein extracting keywords from the clustered writing materials as the theme for each cluster article comprises:
using the summary extraction model to extract summary content from raw writing materials, and using the central sentence extraction model to extract a central sentence or central phrase from the summary content to serve as the theme for one cluster article.

17. The rich-media document auxiliary generation method as claimed in claim 14, wherein the intelligent analysis engine comprises a target analysis engine and an event analysis engine; the target analysis engine uses a target as a center to obtain a statistical law of the target; the intelligent analysis engine uses an event as a center to analyze the background and a development trend of the event; and the intelligent analysis engine finally outputs an analysis conclusion in a form of structured data.

18. The rich-media document auxiliary generation method as claimed in claim 14, wherein generating a video based on the first writing material, the second writing material and the third writing material comprises:
using a sequence model to generate a new text segment following an end of the text information, to acquire a fourth writing material;
using a sequence model to rewrite the text information based on a set style control variable, to acquire a fifth writing material;
using an intelligent summary module to generate a summary based on semantic information of text information, to acquire a sixth writing material;
acquiring an initial document based on the first writing material, the second writing material, the third writing material, the fourth writing material, the fifth writing material and the sixth writing material;
generating the video based on the initial document.

19. The rich-media document auxiliary generation method as claimed in claim 18, wherein generating the video based on the initial document comprises:
performing word and phrase proofreading, punctuation proofreading, syntax proofreading, common sense verification, and fact verification for the initial document, to acquire a proofreading result;
performing quantitatively scoring the fluency, common sense compliance, and factual accuracy of the initial document, to acquire a scoring result;
processing the initial document based on the proofreading result and the scoring result to acquire a target document;
generating the video based on the target document.

20. The rich-media document auxiliary generation method as claimed in claim 19, wherein generating the video based on the target document comprises:
generating a video narration by using a text transfer model based on the target document;
generating subtitles with the video narration, and generating a sound track based on a speech composition model;
segmenting the video narration into sentences based on punctuation marks;
retrieving relevant images and videos based on semantic information of the segmented sentences;
combining the images and the videos with texts in sequence to generate a video-image-text composite, generating the video with voice narration, video images, and subtitles.
